(19) United States
(12) Patent Application Publication
(10) Pub. No.: US 2018/0071064 A1
(43) Pub. Date: Mar. 15, 2018

(54) GLOSSAL ANGLE

(71) Applicants: Metoqua Dzn Anderson, Covington, LA (US); Justin Anderson, Covington, LA (US)

(72) Inventors: Metoqua Dzn Anderson, Covington, LA (US); Justin Anderson, Covington, LA (US)

(21) Appl. No.: 15/706,665

(22) Filed: Sep. 15, 2017

Related U.S. Application Data
(60) Provisional application No. 62/394,957, filed on Sep. 15, 2016.

(51) Int. Cl. A61C 17/00; A61C 1/12; A61C 1/08

(52) U.S. Cl. CPC A61C 17/005; A61C 3/06; A61C 1/08; A61C 1/12

(57) ABSTRACT

A dental prophylaxis glossal angle and assembly for cleaning teeth, tongue, palate and cheek areas is provided. The dental prophy glossal angle has a head removeably attached to an dental handpiece. The head has a first face opposite a second face. The head has a plurality of driven rotors with knobs extending through apertures defined by the first face and outwardly from the first face to receive a respective plurality of prophy cups or brushes to clean and polish the teeth, tongue, palate and cheek areas, and the second face has a tongue scraper adapted to clean tongue, palate, and cheek areas.

### CROSS REFERENCE TO RELATED APPLICATIONS

This application claims the benefit of U.S. Provisional Application No. 62/394,957, filed on Sep. 15, 2016, which is incorporated herein in its entirety by reference.

### BACKGROUND OF THE INVENTION

### Field of the Invention

The present invention generally relates generally to dental instruments for cleaning and polishing teeth and more particularly relates to a dental prophylaxis glossal angle and handpiece assembly.

### Description of the Related Art

With the growing population living longer and healthier due to advances in medicine, personal hygiene, and overall healthcare, people are aiming to take better care of their teeth. One manner in which people promote good hygiene often includes appointments with a dentist professional for regular cleanings of one's teeth, which often needs to accommodate people's busy schedules, for maintaining people's health and well-being.

Over the years, various devices have been made to assist people with the cleaning of their teeth in attempts to reduce the buildup of plaque and reduce risks of gingivitis. When the teeth are cleaned and polished by a dental professional, the dental plaque is essentially removed from the tooth surfaces of the patient. In addition, build-up and extrinsic stains caused by beverages and food such as, for example, coffee, tea, or soda, are also reduced. Today, dental professionals use dental instruments commonly known as dental prophylaxis (prophy) angles for cleaning and polishing teeth. However, such commonly known devices are directed solely at cleaning teeth, are of complex construction, are largely inefficient in operation, and result in leaving bacteria and plaque on a person's tongue. Mere cleaning of teeth in such way is not optimally hygienic or sanitary and can lead to bad breath, the spreading of unhealthy germs, and health concerns. The inventor postulates that oral hygiene which includes cleansing of one's tongue, palate, and cheek areas plays an important role in sustaining a healthy mouth and lasting teeth.

There is a need for a hand-held, efficient, sanitary, and portable device for dental professionals to easily and efficiently clean patients' teeth, gums, and tongue. In such manner, cleaning of a patient's tongue would be added to the dental prophylaxis routine.

One apparatus for cleaning a patient's teeth is provided in U.S. Pat. No. 3,727,313 issued to Graham, which discloses a disposable dental hand piece having a one-piece elongated tubular shank provided with a right angle hollow head at one end integral therewith, and the head is formed with an opening directed at a right angle to the shank for insertion of a gear into the head. The head has a single tool holder knob projecting outwardly to a single cup or brush with which a dental professional would engage a tooth of a patient to clean it.

Another conventional apparatus is provided in U.S. Pat. No. 6,203,322 issued to Kraenzle, which discloses a dental prophy angle having a forward end formation with a hinged closure that allows access to the gears and drive shaft inside of the angle. The closure is secured in a fixed position on the forward end formation by locking elements. The prophy angle includes a drive shaft that drives a single rotor in the head of the angle. The drive shaft is driven by a driving mechanism in a dental handpiece and the prophy angle is attached to the handpiece in a conventional fashion.

More recently, U.S. Pat. No. 7,955,079 issued to Chronister provides a dental prophylaxis angle and handpiece assembly for cleaning and polishing teeth, where the dental prophy angle is removably attached to the dental handpiece by an interlocking mechanism. The prophy angle has a single prophy cup which is pressed against an individual tooth surface to clean and polish each tooth. The prophy angle can be securely snap-fitted onto the handpiece, and the entire prophy angle is disposed of after one-time use on a patient. All aforementioned referenced patents are incorporated herein by reference.

The primary shortcomings are inefficiency in promoting overall oral hygiene, inconvenience and wasteful in operation, and hygienic concerns. The conventional devices only clean the coronal areas of individual teeth.

While these units may be suitable for the particular purpose employed, they would not be as suitable for the purposes of the present invention as disclosed hereafter.

Accordingly, there is a need for a compact portable lightweight hand-held device for dental professionals to easily and efficiently clean patients' teeth, tongue, palate and cheek areas to remove or reduce plaque and bacteria.

As disclosed in this application, the inventor has discovered novel and unique devices and methods for efficient and effective cleaning of people's tongue, palate, and cheek areas, which exhibit superlative oral hygiene properties without being dependent on multitudes of separate hand-held devices or wasteful or complex components.

Embodiments of the present invention provide for devices and methods and disclosed herein and as defined in the annexed claims which provide for improved oral hygienic cleaning features in order to efficiently clean a person's tongue, palate and cheek areas in a timely and efficient manner, for people's health and well-being.

Embodiments of the present invention provide for glossal angles and methods as defined in the annexed claims which provide for improved set up, operating, and cleaning characteristics in order to efficiently clean various types of surfaces of interest for a multitude of areas of a person's mouth.

### SUMMARY OF THE INVENTION

It is one prospect of the present invention to provide one or more novel devices of simple but effective construction which can be applied to many surfaces of a person's mouth to efficiently and effectively remove and dispose plaque and bacteria.

The following presents a simplified summary of the present disclosure in a simplified form as a prelude to the more detailed description that is presented herein.

Therefore, in accordance with embodiment of the invention, there is provided a dental prophy angle device that has an elongated tubular body having a proximal end opposite a distal end and a central bore extending therethrough. The proximal end is open-ended and is adapted for removable attachment to a dental handpiece. The dental prophy angle preferably has an elongated flexible drive shaft extending through the tubular member. The drive shaft has a proximal end opposite a distal end. Preferably, the distal end of the drive shaft has a beveled drive gear.

In a preferred embodiment, the dental prophy angle has a hollow head disposed at the distal end of the tubular body, and the head has a generally planar first face portion opposite a second face portion. The first face portion defines a plurality of apertures adapted to receive and rotatably secure driven rotors, and the second face portion has a tongue scraper extending outwardly therefrom. The head preferably comprises a plurality of driven rotors having respective first ends disposed within the head opposite second ends which extend outwardly from the head through the apertures. Preferably, at least one driven rotor comprises a beveled driven gear on the first end mounted within the head such that the drive gear of the shaft can intermesh with the driven gear of the driven rotor. Preferably, the at least one driven rotor that has a beveled driven gear also has a pinion gear, and at least a second driven rotor comprises a pinion gear adapted to intermesh with the pinion gear of the at least one driven rotor for driving the second driven rotor.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a back right perspective view of an exemplary glossal angle device in accordance with an embodiment of the invention;

FIG. 2 is a front right partially bottom perspective view thereof;

FIG. 3 is a left elevation view of an embodiment of the invention;

FIG. 4 is a front elevation view thereof;

FIG. 5 is a cross sectional view along line 5-5 of FIG. 4;

FIG. 6 is a cross sectional view along line 6-6 of FIG. 4;

FIG. 7 is a back elevation view of a face of a head in accordance with embodiments of the invention;

FIG. 8 is an elevation view showing exemplary gears and a shaft in accordance with embodiments of the invention;

FIG. 9 is top view of an exemplary head in accordance with an embodiment of the invention;

FIG. 10 is a right side partial break away elevation view in accordance with embodiments of the invention;

FIG. 11 is a left side partial break away elevation close up view in accordance with embodiments of the invention;

FIG. 12 is a front side partial break away elevation close up view in accordance with embodiments of the invention;

FIG. 13 is an exploded perspective view in accordance with embodiments of the invention;

FIG. 14 is an exploded side elevation view in accordance with embodiments of the invention;

FIG. 15 is an exploded side elevation partly perspective view of FIG. 14 in accordance with embodiments of the invention;

FIG. 16 is a top view of an exemplary head of a prophy glossal angle in accordance with embodiments of the invention;

FIG. 17 is a partial break away top view thereof in accordance with embodiments of the invention;

FIG. 18 is a partial break away top view thereof in accordance with embodiments of the invention;

FIG. 19 is an exploded top perspective view thereof in accordance with embodiments of the invention;

FIG. 20 is an exploded top view thereof in accordance with embodiments of the invention; and

FIG. 21 is an exploded bottom view thereof in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

In accordance with embodiments of the invention, there is provided a dental prophy glossal angle for efficiently cleaning a person's teeth, tongue, palate and cheek areas in a timely and efficient manner, for people's health and well-being.

The basic constructional details and principles of operation of one embodiment of a prophy glossal angle device 100 according to a preferred embodiment of the present invention will be discussed.

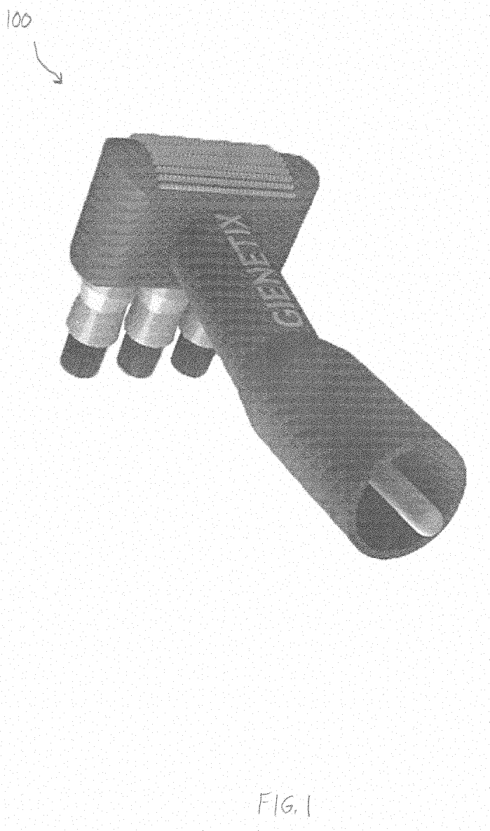

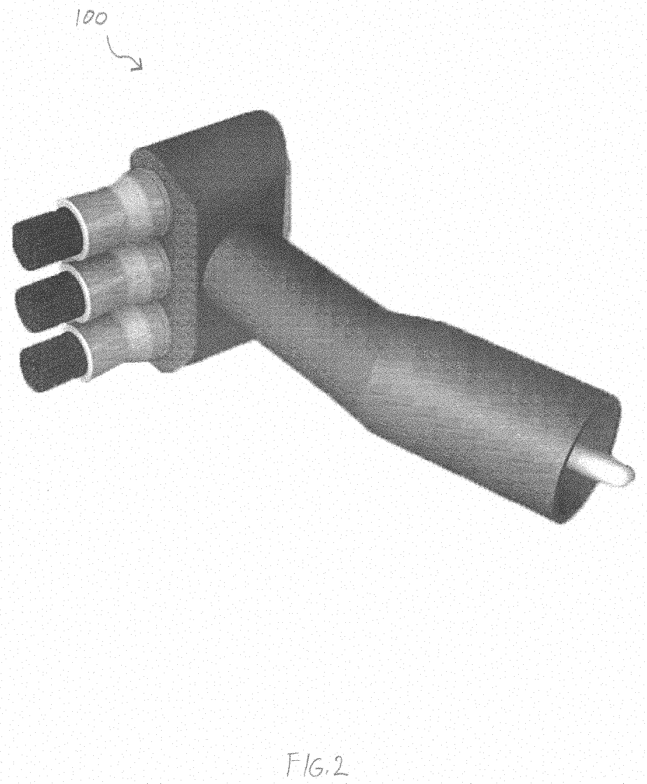

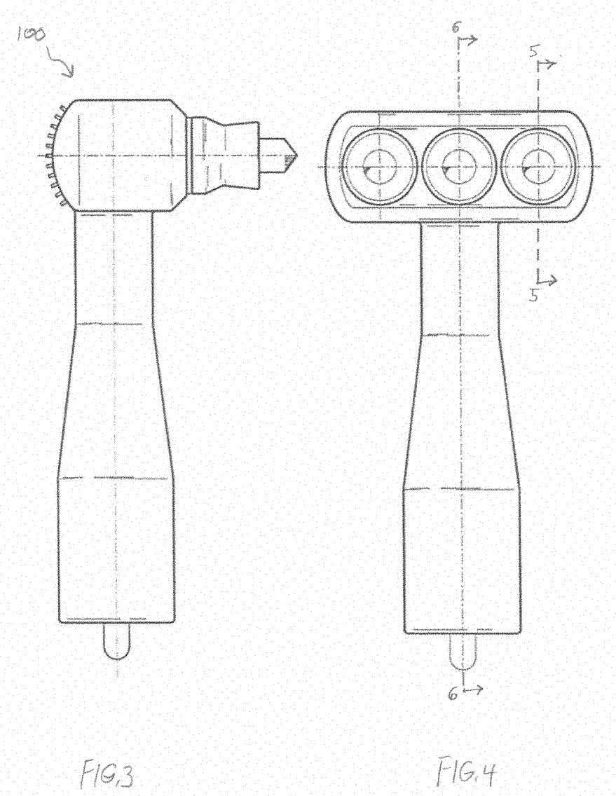

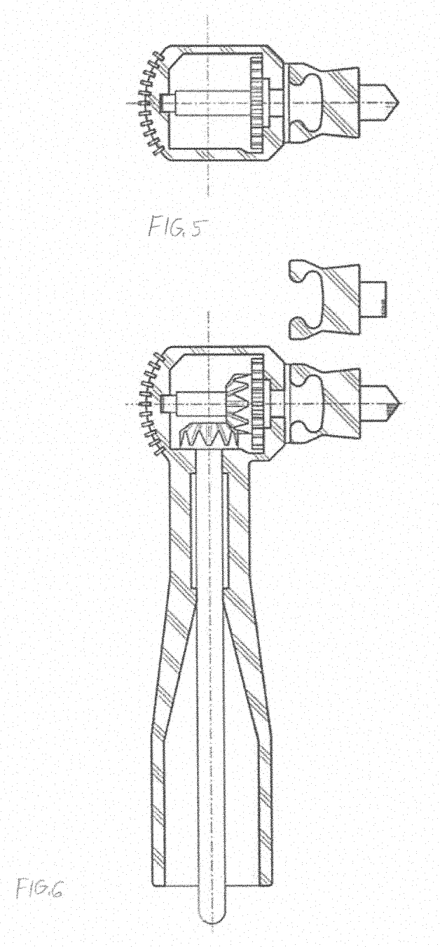

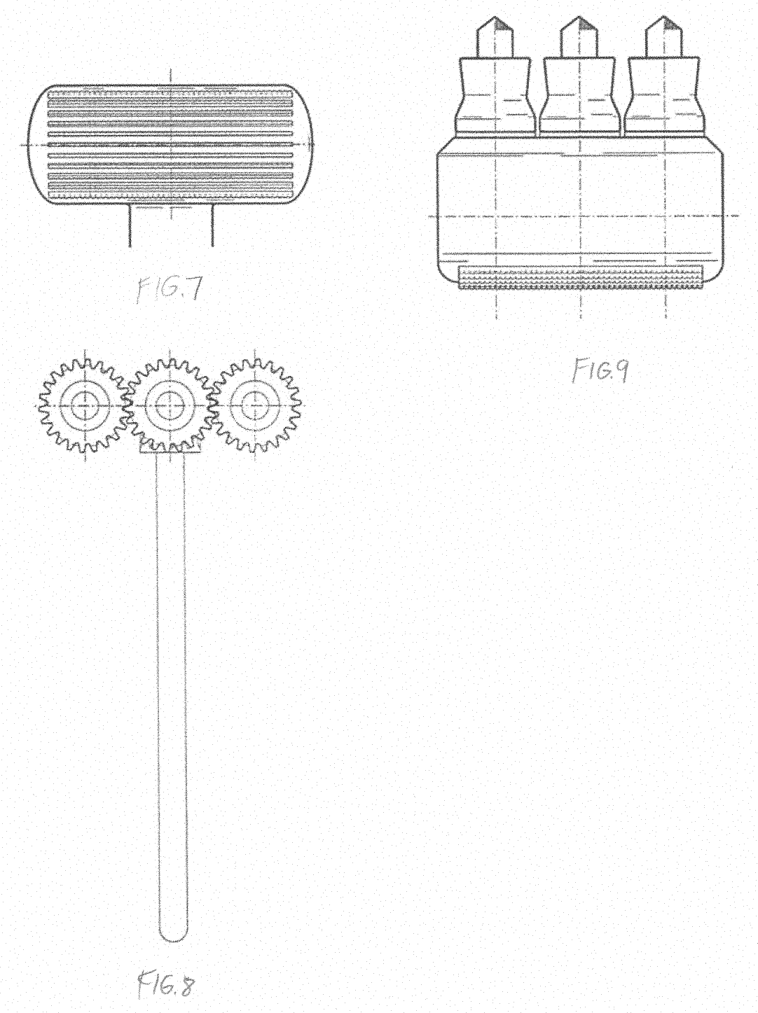

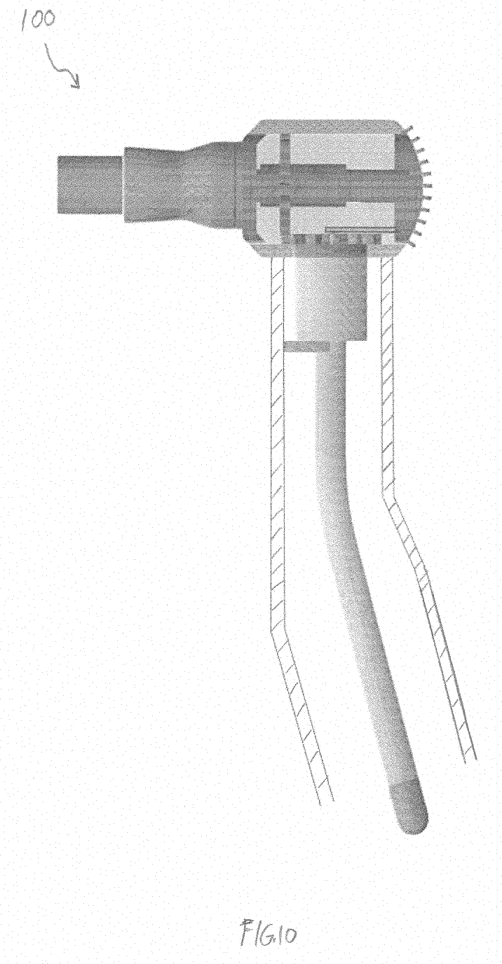

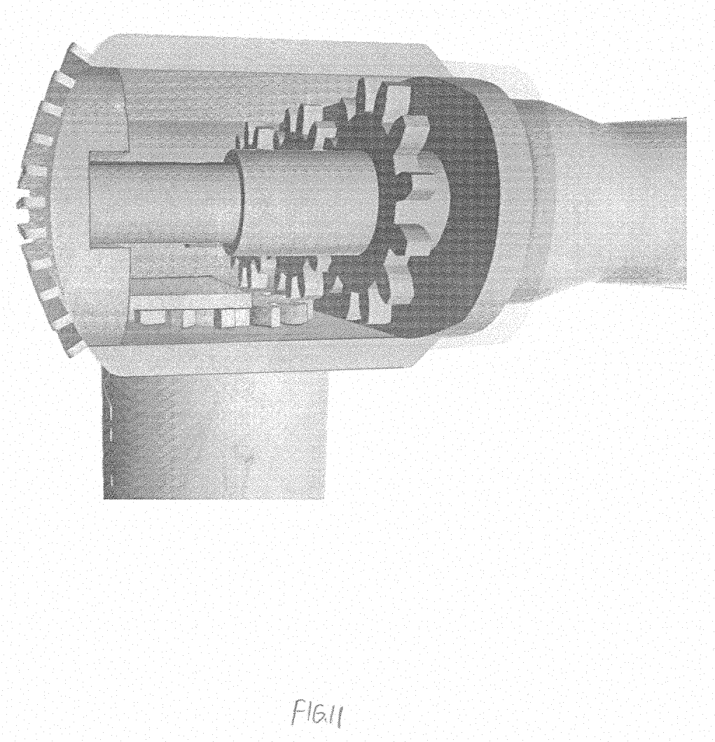

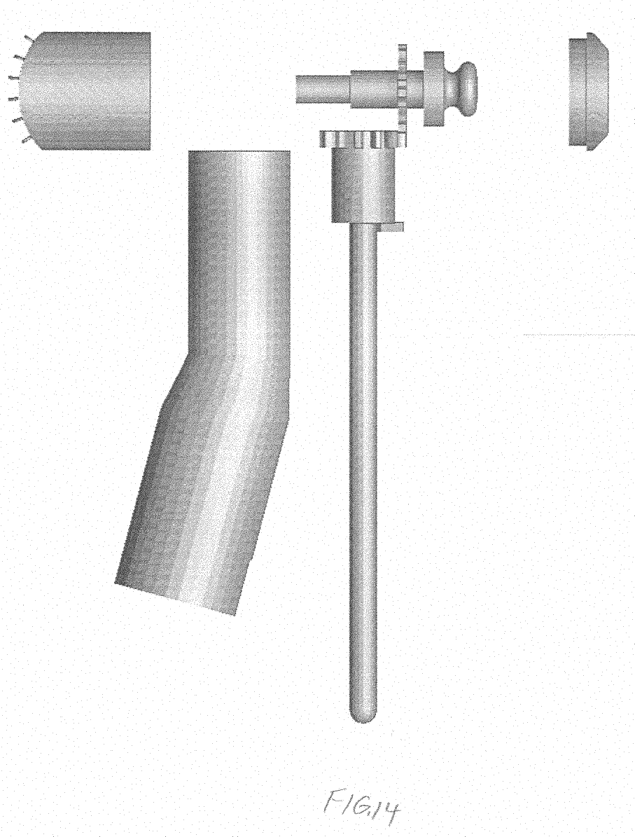

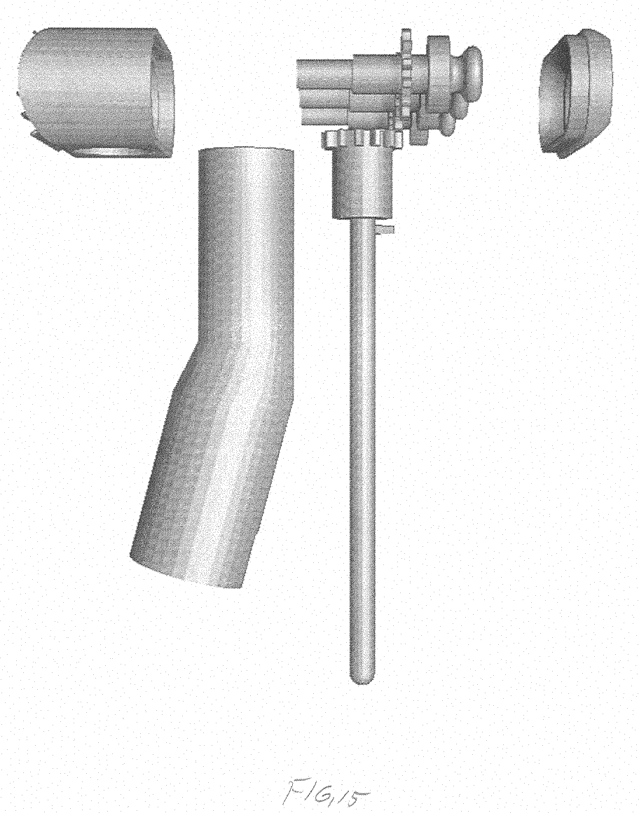

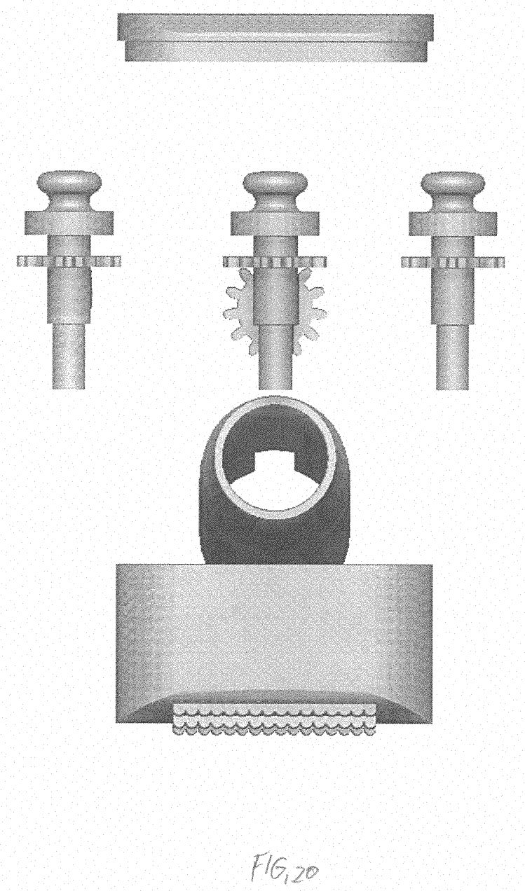

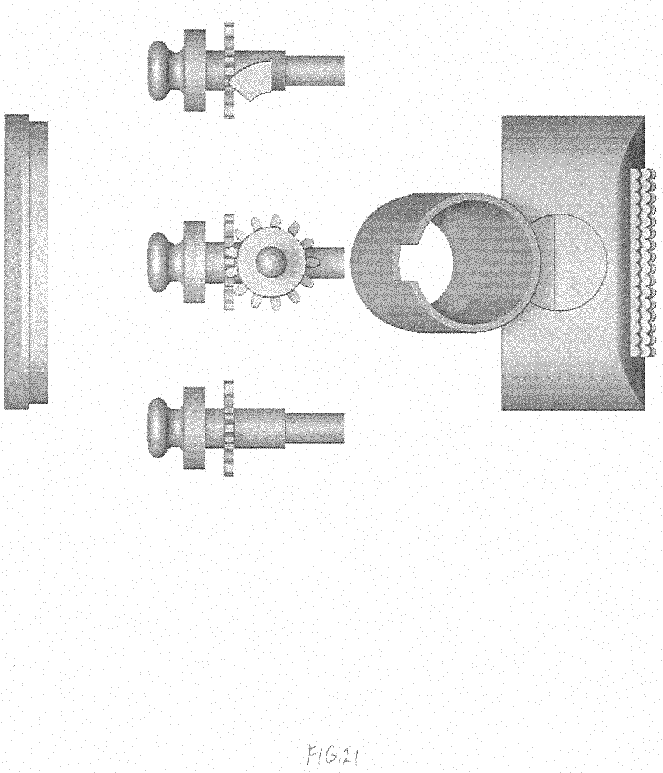

A prophy angle device 100 according to a preferred embodiment of the present invention is provided. As illustrated in FIGS. 1-21, the device 100 comprises an elongated tubular body 102 having a proximal end 102a opposite a distal end 102b and a central bore 104 extending therethrough, the proximal end being 102a open-ended and adapted for removable attachment to a dental handpiece. An elongated drive shaft 106 extends through said tubular member 102, said drive shaft 106 having proximal end 106a opposite a distal end 106b, said distal end 106b of said drive shaft 106 having a beveled drive gear 108, as illustrated in FIG. 6. Preferably, a hollow head 110 is disposed at the distal end 102b of said tubular body 102, the head portion 110 having a generally planar first face 112 opposite a second face 114, the first face 112 defining a plurality of apertures 116 (as illustrated in FIGS. 13 and 19) adapted to receive and rotatably secure driven rotors 118 as illustrated, for example, in FIGS. 11, 17, 18 and 19, the second face 114 comprising a tongue scraper 120 extending outwardly therefrom (as seen in FIG. 7). The hollow head 110 preferably comprises a plurality of driven rotors 118 having respective first ends 118a disposed within said head portion 110 opposite second ends 118b extending outwardly from said head portion 110 through said apertures 116, wherein at least one said driven rotor 118 comprises a beveled driven gear 122, as illustrated in FIG. 6, on said first end 118a mounted within said head portion 110 such that the drive gear 108 of the shaft 106 can intermesh with the driven gear 122 of the driven rotor 118 as seen in FIG. 6, wherein the at least one said driven rotor 118 further comprises a pinion gear 124, and wherein (as can be seen in FIG. 5) at least the second driven rotor 118 comprises a pinion gear 124 adapted to intermesh, as exemplified in FIG. 8, with said pinion gear 124 of the at least one driven rotor 118 for driving (in the exemplary direction of Arrow B) said second driven rotor 118 (in the respective exemplary direction of Arrow C). Referring to FIGS. 4-6 and 8, when shaft 106 with drive gear 108 is rotated, for example, in direction exemplified by Arrow A, the drive gear 108 drives the beveled driven gear 122 and respective pinion gear 124 of the driven rotor 118 in the direction exemplified by arrow B; accordingly, as indicated above, the pinion gear 124 of the first driven rotor 118 intermeshes with and drives the pinion gear 124 of the second driven rotor 118 in the direction exemplified by arrow C, as can be seen in the embodiments illustrated in FIG. 8. The drive gear 108 transfers rotating motion to the beveled driven gear 122 of the first driven rotor 118. The pinion gear 124 of the first driven rotor 118 transfers rotating motion to pinion gear 124 of the second driven rotor 118.

In a preferred embodiment, as illustrated in FIG. 8, the prophy angle device 100 further comprises at least a third driven rotor 118 comprising a pinion gear 124 adapted to intermesh with said pinion gear 124 of the at least one driven rotor 118 for driving (in the exemplary direction of Arrow B) the third driven rotor 118 (in the respective exemplary direction of Arrow D). Accordingly, as indicated above, the pinion gear 124 of the first driven rotor 118 intermeshes with and drives the pinion gear 124 of the third driven rotor 118 in the direction exemplified by arrow D, as can be seen in the embodiments illustrated in FIG. 8. The drive gear 108 transfers rotating motion to the beveled driven gear 122 of the first driven rotor 118. The pinion gear 124 of the first driven rotor 118 transfers rotating motion to pinion gear 124 of the third driven rotor 118. Preferably, the plurality of driven gears 118 are in linear alignment (as illustrated along axis 126) adapted to clean along the width of a patient's tongue, and said linear alignment is characterized as orthogonal to the axis 128 of the drive shaft 106. It can be appreciated that the plurality of rotors 118 can also be configured in non-linear alignment, in yet another embodiment, for example, where the middle rotor 118 and pinion gear 124 seen in FIG. 8 are on axis 126 and the adjacent side rotors 118 and respective pinion gears 124 are on axis 144 (FIG. 8), to conform, for instance, to the top of a patient's mouth or cheek area, at the option of the user; and in such embodiment, a plurality of nonlinearly positioned apertures 116 are adapted to receive and rotatably secure driven rotors 118 to support and rotate respective tongue brushes or prophylaxis cups 132. As can be seen, embodiments of the present invention provide for efficient removal of plaque and bacteria for cleaning a patient's tongue, palate, and cheek area

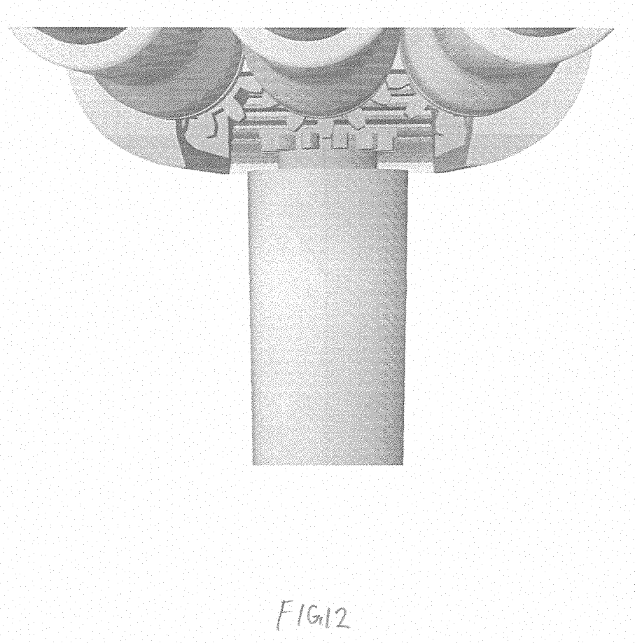

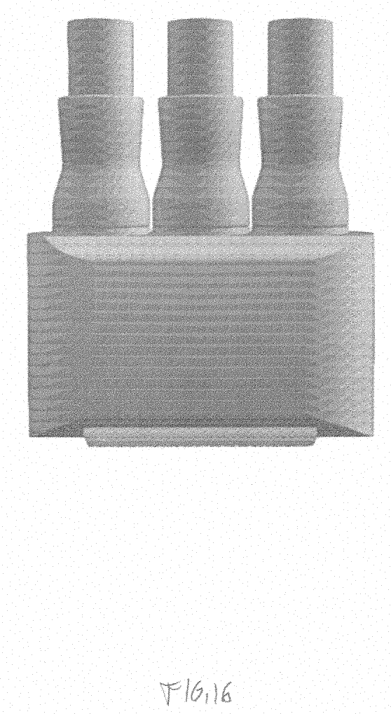

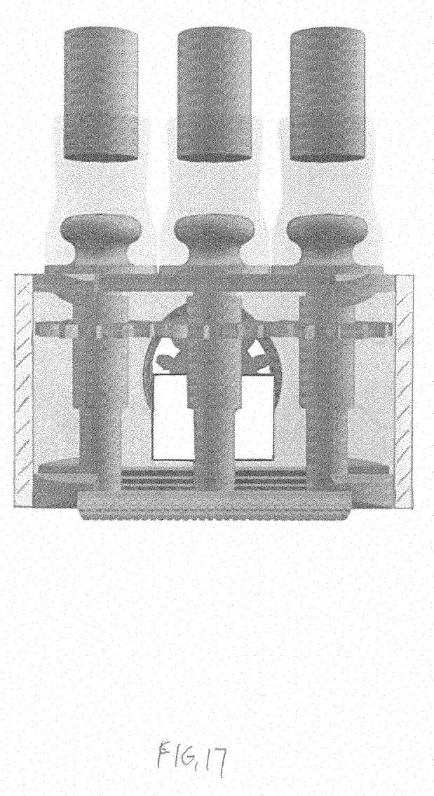

The first face 112 preferably defines a plurality of linearly positioned apertures 116 adapted to receive and rotatably secure driven rotors 118 to support and rotate respective tongue brushes or prophylaxis cups 132, as seen in FIGS. 6-12 and 16-18, adapted to clean a user's tongue, palate, teeth and cheek area. As seen in FIGS. 5-6, the outer end of the driven rotor 118 preferably has a flange 140 and a button head 142 adapted for removeably receiving the tongue brushes or prophylaxis cups 132 or other dental elements. In one embodiment, the rotating tongue brushes 132 comprise nylon bristles which rotate and remove plaque and bacteria from patients' respective tongues. The brush 132 bristles can be tapered or flat, as seen in FIG. 6, and the length of each brush 132 connected to each respective button heads 142 of the plurality of rotors 118 can be the either same length or can be a different length, at the option of the user. For example, the three brushes illustrated in FIG. 9 are of equal length, yet in another embodiment, for example, the middle brush 132 the three illustrated brushes 132 can have a length exceeding the length of the adjacent side brushes 132, to conform to the top of a patient's mouth, at the option of the user. As can be seen, embodiments of the present invention provide for efficient removal of plaque and bacteria for cleaning a patient's tongue, palate, and cheek area. In one embodiment, as seen in FIGS. 13-15, the head 110 comprises a bottom surface 115 which defines a mounting aperture 117 adapted for removeable attachment directly to a dental handpiece or for removeable attachment to the elongated tubular body 102 exemplified in the Figures which comprises a distal end 102b adapted for removable attachment to a dental handpiece. In a preferred embodiment, the second face 114 is characterized as generally arcuate, as seen in FIGS. 14 and 15.

Preferably, referring to FIGS. 6, 10 and 14, the axis 130 of at least one driven rotor of the prophy angle is angled at 90 degrees relative to the axis 128 of the distal end 106b of the driving shaft 106 of the prophy angle 100.

Preferably, referring to FIGS. 6, 10, 14 and 15, the axis 130 of each driven rotor 118 of said plurality of driven rotors 118 (as can be seen in FIG. 15) of the prophy angle 100 is angled at 90 degrees relative to the axis 128 of the distal end 106b of the driving shaft 106 of the prophy angle 100.

In one embodiment, the axis 130 of each driven rotor 118 of said plurality of driven rotors 118 of the prophy angle is angled at an angle in the range of about 90 degrees to about 130 degrees relative to the axis 128 of the distal end 106b of the driving shaft 106 of the prophy angle 100.

Referring to FIGS. 13-19, preferably, the plurality of driven rotors 118 are rotatably held in place by said planar first face 112 and said second face 114 of said head 110, and the driven rotors 118 are rotated when the driving shaft 106 is rotated (as discussed above and below and illustrated in FIGS. 8 and 19, by example).

As seen in FIGS. 7, 9, 10, 11, 14, and 19-21, in yet another embodiment, the tongue scraper 120 comprises a plurality of rows of linear projections extending radially outwardly from the second face portion 114 which is characterized as generally arcuate, as exemplified in the Figures.

Preferably, as illustrated in the Figures, the tongue scraper 120 comprises a plurality of rows of linear projections extending orthogonally outwardly from the second face portion 114 which is characterized as flat (not shown).

In one embodiment, the tongue scraper 120 comprises a plurality of segregated brushes 121 projecting radially outwardly from the second face portion 114 which is characterized as generally arcuate.

Preferably, the tongue scraper 120 comprises a plurality of segregated brushes 121 projecting orthogonally outwardly from the second face portion 114 which is characterized as flat.

In a preferred embodiment, a prophy angle device 100 is provided having an elongated tubular body 102 with a proximal end 102a opposite a distal end 102b and a central bore 104 extending therethrough. Preferably, the proximal end 102a is open-ended and adapted for removable attachment to a dental handpiece.

Referring to FIGS. 15-21, the prophy angle device 100 comprises an elongated drive shaft 106 extending through the tubular member 102, said drive shaft 106 having proximal end 106a opposite a distal end 106b, and said distal end 106b of said drive shaft 106 has a pinion drive gear 109.

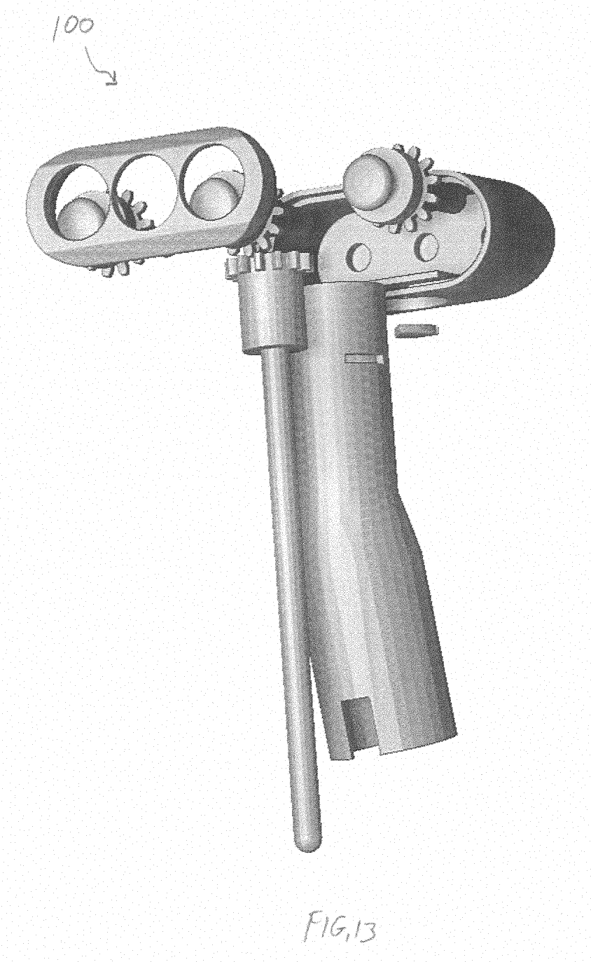

Preferably, the prophy angle device 100 comprises a hollow head portion 110 disposed at the distal end 102b of the tubular body 102, the head portion 110 having a generally planar first face portion 112 opposite a generally arcuate second face portion 114, as see in FIG. 10. The first face 112 preferably defines a plurality of linearly positioned apertures 116 adapted to receive and rotatably secure driven rotors 118 to support and rotate respective tongue brushes or prophylaxis cups 132, as seen in FIGS. 6-12 and 16-18, adapted to clean a user's tongue. In one embodiment, the rotating tongue brushes 132 comprise nylon bristles which rotate and remove plaque and bacteria from patients' respective tongues. The brush 132 bristles can be tapered or flat, as seen in FIG. 6, at the option of the user. As can be seen, embodiments of the present invention provide for efficient removal of plaque and bacteria for cleaning a patient's tongue, palate, and cheek area.

The second face 114 of the head preferably comprises a tongue scraper 120 extending outwardly therefrom and is adapted to clean a user's tongue.

The prophy angle device 100 preferably comprises a plurality of driven rotors 118 having respective first ends 118a disposed within said head portion 110 opposite second ends 118b extending outwardly from said head portion 110 through said apertures 116, wherein at least one said driven rotor 118 comprises a pinion driven gear 124 on said first end mounted within said head portion 110, such that the drive gear 109 of the shaft 106 can intermesh with the driven gear 124 of the driven rotor, as illustrated in FIGS. 10-15 and 17-21, for driving the driven rotor 118. Preferably, at least a second driven rotor 118 comprises a pinion gear 124 adapted to intermesh with the pinion gear 124 of the at least one driven rotor 118 for driving the second driven rotor 118, as illustrated, for example, in FIGS. 8, 11 and 17-21.

In a preferred embodiment, the plurality of driven gears 118 are in linear alignment, as seen along axis 126, for example, in FIG. 8, and the linear alignment is characterized as orthogonal to the axis 128 of the distal end 106b of the drive shaft 106.

Preferably, the plurality of driven rotors 118 are rotatably (e.g., Arrows B, C, and D) held in place by the generally planar first face 112 and second face 114 of the head portion 110 and are rotated (e.g., in the direction of Arrows B, C, and D) when said driving shaft 106 is rotated (e.g., in the exemplary direction of Arrow A), as illustrated in FIG. 8 and FIG. 19. As can be seen FIG. 10, 13, 14-15, a retention insert 134 is adapted to be inserted into and tightly fitted within a retention port 136 (FIG. 13) defined by the tubular body 102, and an inner portion 134a of the retention insert 134 is configured to engaged a portion of the shaft 106b and a bottom portion of the pinion drive gear 109 to provide resistance against movement (in the direction of Arrow E) of the shaft 106 and respective pinion drive gear 109 along axis 128 as shown in FIG. 10. FIGS. 10-11 and 13 show a retention plate 138 disposed within the head 110 and preferably fixed to the second face wall 114 to provide resistance against movement (in the direction of Arrow F) of the shaft 106 and respective pinion drive gear 109 along axis 128. In other words, as seen in FIG. 10, the pinion drive gear 109 is ‘sandwiched’ between the retention insert 134 and retention plate 138, to prevent axial movement of the pinion drive gear 109 along axis 128. Referring to FIGS. 11, 12 and 19, when shaft 106 with pinion drive gear 109 is rotated, for example, in a direction exemplified by Arrow A, the pinion drive gear 109 drives the pinion gear 124 of the driven rotor 118 in the direction exemplified by arrow B; accordingly, as indicated above, the pinion gear 124 of the first driven rotor 118 intermeshes with and drives the pinion gear 124 of the second driven rotor 118 in the direction exemplified by arrow C, as can be seen in the embodiments illustrated in FIG. 19. The pinion drive gear 109 transfers rotating motion to the pinion gear 124 of the first driven rotor 118 (Arrow B). The pinion gear 124 of the first driven rotor 118 transfers rotating motion to pinion gear 124 of the second driven rotor 118 (Arrow C). In a preferred embodiment, as further illustrated in FIG. 19, the prophy angle device 100 further comprises at least a third driven rotor 118 comprising a pinion gear 124 adapted to intermesh with said pinion gear 124 of the at least one driven rotor 118 for driving (in the exemplary direction of Arrow B) the third driven rotor 118 (in the respective exemplary direction of Arrow D). Accordingly, as indicated above, the pinion gear 124 of the first driven rotor 118 intermeshes with and drives the pinion gear 124 of the third driven rotor 118 in the direction exemplified by arrow D, as can be seen in the embodiments illustrated in FIG. 19. In other words, the pinion gear 124 of the first driven rotor 118 transfers rotating motion to the pinion gear 124 of the third driven rotor 118 (Arrow D).

In one embodiment, the tongue scraper 120 of the prophy angle device 100 comprises a plurality of rows 120 of linear projections extending radially outwardly from the second face portion 114.

In one embodiment, the tongue scraper 120 of the prophy angle device 100 comprises a plurality of rows 120 of linear projections extending radially outwardly from the second face portion 114 which is characterized as generally arcuate. In one embodiment, the tongue scraper 120 comprises nylon bristles which remove plaque and bacteria from patients' respective tongues.

In one embodiment, the tongue scraper 120 of the prophy angle device 100 comprises a plurality of rows of linear projections 120 extending orthogonally outwardly from the second face portion 114 which is characterized as flat.

In yet another embodiment, the tongue scraper 120 of the prophy angle device 100 comprises a plurality of segregated brushes 121 projecting radially outwardly from the second face portion 114 which is characterized as generally arcuate.

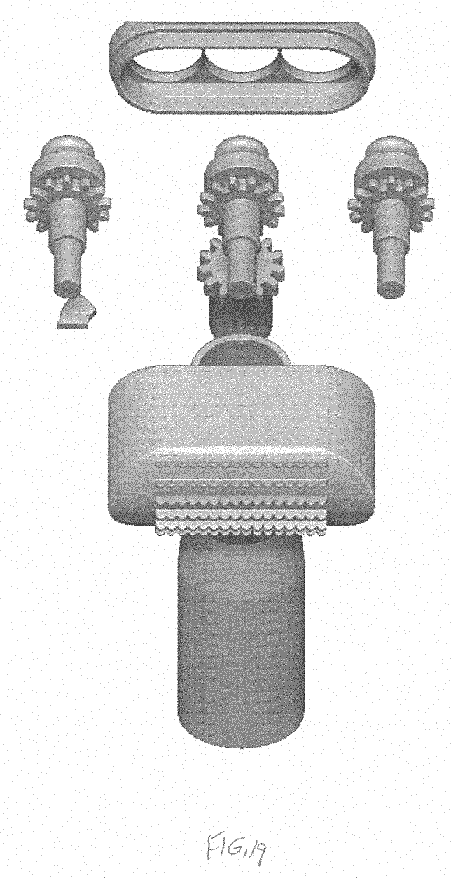

Preferably, the tongue scraper 120 of the prophy angle device 100 comprises a plurality of segregated brushes (e.g., 121 in FIG. 18) projecting orthogonally outwardly from the second face portion 114, which is characterized as flat (not shown).

In another preferred embodiment, a glossal angle device 100 comprises an elongated tubular body 102 having a proximal end 102a opposite a distal end 102b and a central bore 104 extending therethrough, the proximal end 102a being open-ended, as illustrated in FIGS. 1, 2, 6, 10, 20 and 21, and adapted for removable attachment to a dental handpiece. An elongated drive shaft 106 extends through the tubular member 102, said drive shaft having proximal end 106a opposite a distal end 106b, the distal end 106b of said drive shaft 106 having a beveled drive gear 108 as illustrated in FIG. 6, or a pinion drive gear 109 as illustrated in FIGS. 10 and 11.

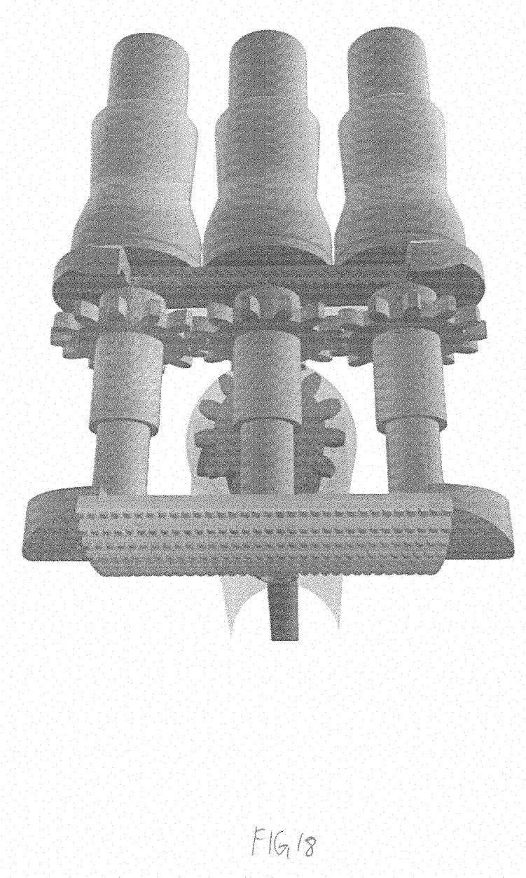

Preferably, the glossal angle device 100 comprises a hollow head portion 110 disposed at the distal end of said tubular body 102, the head portion 110 having a generally planar first face portion 112 opposite a second face portion 114, the first face portion defining a plurality of linearly positioned apertures 116 adapted to receive and rotatably secure driven rotors 118 to support and rotate respective tongue brushes 132 adapted to clean a user's tongue, the second face portion comprising a tongue scraper 120 extending outwardly therefrom adapted to clean said user's tongue; the glossal angle device 100 comprises a plurality of driven rotors 118 having respective first ends 118a disposed within said head portion 110 opposite second ends 118b extending outwardly from said head portion 110 through said apertures 116, wherein at least one said driven rotor 118 comprises a beveled driven gear 122 on said first end mounted within said head portion 110 such that the drive gear 108 (or 109) of the shaft 106 can intermesh with the beveled driven gear 122 of the driven rotor 118 as illustrated in FIG. 6, wherein the at least one driven rotor 118 further comprises a pinion gear 124, and wherein at least a second driven rotor 118 comprises a pinion gear 124 adapted to intermesh with said pinion gear 124 of the at least one driven rotor 118 for driving said second driven rotor 118, as illustrated in FIG. 8. In another embodiment, the at least one driven rotor 118 comprises a driven pinion gear 124 on said first end 118a mounted within said head portion 110 such that a pinion drive gear 109 of the shaft 106 can intermesh with the driven pinion gear 124 of the driven rotor 118 as seen in FIGS. 10-11, and wherein at least a second driven rotor 118 comprises a pinion gear 124 adapted to intermesh with said pinion gear 124 of the at least one driven rotor 118 for driving the second driven rotor 118, as illustrated in FIGS. 17-21. Referring to FIGS. 13, 15 and 16, in one embodiment, removal of one of the three illustrated rotors 118 from the head 110 would enable water or an oral cleaning solution jetted through the tubular body to released or dispensed from the head 110 while rotating the rotors 118 and respective brushes 132 in a patient's mouth during the dental prophylaxis cleaning procedure, to provide for increased efficiency in oral cleaning. In yet another embodiment, an aperture 146 is provided in the second face 114 of the head 110 to allow water or an oral cleaning solution jetted through the tubular body 102 to be released or dispensed through the second face 114 of the head 110 while rotating the rotors 118 and respective brushes 132 extending outwardly from the opposing first face 112 of the head 110 in a patient's mouth during the dental prophylaxis cleaning procedure, to provide for increased efficiency in oral cleaning. Through embodiments of the invention disclosed herein, the inventor has disclosed a hydro-glossal angle. Conventional prophy angles do not remove plaque and bacteria from a patient's tongue and cheek area. Yet, as can be seen herein, embodiments of the present invention provide a glossal angle 100 for efficient removal of debris, plaque and bacteria for cleaning a patient's tongue, palate, and cheek area in addition to cleaning a patient's teeth, for better oral health. Through embodiments of the invention, cleaning a patient's tongue could be efficiently added to the dental prophylaxis routine. Embodiments of the invention provide for a powered gum stimulator, a powered facial cleaner, powered tongue scraper, and water powered tongue device.

Preferably, the axis of at least one driven rotor of the glossal angle device 100 is angled at 90 degrees relative to the axis of the driving shaft of the glossal angle.

In yet another embodiment, the second face portion is characterized as generally arcuate.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A dental prophy angle device comprising:
an elongated tubular body having a proximal end opposite a distal end and a central bore extending therethrough, the proximal end being open-ended and adapted for removable attachment to a dental handpiece;
an elongated drive shaft extending through said tubular member, said drive shaft having proximal end opposite a distal end, said distal end of said drive shaft having a beveled drive gear;
a hollow head disposed at the distal end of said tubular body, the head having a generally planar first face opposite a second face, the first face defining a plurality of apertures adapted to receive and rotatably secure driven rotors, the second face comprising a tongue scraper extending outwardly therefrom; and
a plurality of driven rotors having respective first ends disposed within said head opposite second ends extending outwardly from said head through said apertures, wherein at least one said driven rotor comprises a beveled driven gear on said first end mounted within said head such that the drive gear of the shaft can intermesh with the driven gear of the driven rotor, wherein the at least one said driven rotor further comprises a pinion gear, wherein at least the second driven rotor comprises a pinion gear adapted to intermesh with said pinion gear of the at least one driven rotor for driving said second driven rotor.

2. The prophy angle device of claim 1, further comprising at least a third driven rotor comprising a pinion gear adapted to intermesh with said pinion gear of said at least one driven rotor for driving said third driven rotor.

3. The prophy angle device of claim 1, wherein the plurality of driven gears are in linear alignment, said linear alignment characterized as orthogonal to the axis of the drive shaft.

4. The prophy angle device of claim 1, wherein the second face is characterized as generally arcuate.

5. The prophy angle device of claim 1, wherein the axis of at least one driven rotor of the prophy angle is angled at 90 degrees relative to the axis of the distal end of the driving shaft of the prophy angle.

6. The prophy angle device of claim 1, wherein the axis of each driven rotor of said plurality of driven rotors of the prophy angle is angled at 90 degrees relative to the axis of the distal end of the driving shaft of the prophy angle.

7. The prophy angle device of claim 1, wherein the axis of each driven rotor of said plurality of driven rotors of the prophy angle is angled at an angle in the range of about 90 degrees to about 130 degrees relative to the axis of the distal end of the driving shaft of the prophy angle.

8. The prophy angle device of claim 1, wherein the plurality of driven rotors are rotatably held in place by said planar first face and said second face of said head and are rotated when said driving shaft is rotated.

9. The prophy angle device of claim 1, wherein the tongue scraper comprises a plurality of rows of linear projections extending radially outwardly from the second face which is characterized as generally arcuate.

10. The prophy angle device of claim 1, wherein the tongue scraper comprises a plurality of rows of linear projections extending orthogonally outwardly from the second face which is characterized as flat.

11. The prophy angle device of claim 1, wherein the tongue scraper comprises a plurality of segregated brushes projecting radially outwardly from the second face which is characterized as generally arcuate.

12. The prophy angle device of claim 1, wherein the tongue scraper comprises a plurality of segregated brushes projecting orthogonally outwardly from the second face which is characterized as flat.

13. A prophy angle device comprising:
an elongated tubular body having a proximal end opposite a distal end and a central bore extending therethrough, the proximal end being open-ended and adapted for removable attachment to a dental handpiece;
an elongated drive shaft extending through said tubular member, said drive shaft having proximal end opposite a distal end, said distal end of said drive shaft having a pinion drive gear;
a hollow head disposed at the distal end of said tubular body, the head having a generally planar first face opposite a generally arcuate second face, the first face defining a plurality of linearly positioned apertures adapted to receive and rotatably secure driven rotors to support and rotate respective tongue brushes adapted to clean a user's tongue, the second face comprising a tongue scraper extending outwardly therefrom adapted to clean a user's tongue; and
a plurality of driven rotors having respective first ends disposed within said head opposite second ends extending outwardly from said head through said apertures, wherein at least one said driven rotor comprises a pinion driven gear on said first end mounted within said head, such that the drive gear of the shaft can intermesh with the driven gear of the driven rotor for driving said driven rotor, and wherein at least a second driven rotor comprises a pinion gear adapted to intermesh with said pinion gear of said at least one driven rotor for driving said second driven rotor.

14. The prophy device of claim 13, wherein the plurality of driven gears are in linear alignment, said linear alignment characterized as orthogonal to the axis of the distal end of the drive shaft.

15. The prophy angle device of claim 13, wherein the plurality of driven rotors are rotatably held in place by said generally planar first face and said second face of said head and are rotated when said driving shaft is rotated.

16. The prophy angle device of claim 13, wherein the tongue scraper comprises a plurality of rows of linear projections extending radially outwardly from the second face.

17. The prophy angle device of claim 13, wherein the tongue scraper comprises a plurality of rows of linear projections extending radially outwardly from the second face which is characterized as generally arcuate.

18. The prophy angle device of claim 13, wherein the tongue scraper comprises a plurality of rows of linear projections extending orthogonally outwardly from the second face which is characterized as flat.

19. The prophy angle device of claim 13, wherein the tongue scraper comprises a plurality of segregated brushes projecting radially outwardly from the second face which is characterized as generally arcuate.

20. The prophy angle device of claim 13, wherein the tongue scraper comprises a plurality of segregated brushes projecting orthogonally outwardly from the second face which is characterized as flat.

21. A glossal angle device comprising:
an elongated tubular body having a proximal end opposite a distal end and a central bore extending therethrough, the proximal end being open-ended and adapted for removable attachment to a dental handpiece;
an elongated drive shaft extending through said tubular member, said drive shaft having proximal end opposite a distal end, said distal end of said drive shaft having a beveled drive gear;
a hollow head disposed at the distal end of said tubular body, the head having a generally planar first face opposite a second face, the first face defining a plurality of linearly positioned apertures adapted to receive and rotatably secure driven rotors to support and rotate respective tongue brushes adapted to clean a user's tongue, the second face comprising a tongue scraper extending outwardly therefrom adapted to clean said user's tongue;
a plurality of driven rotors having respective first ends disposed within said head opposite second ends extending outwardly from said head through said apertures, wherein at least one said driven rotor comprises a beveled driven gear on said first end mounted within said head such that the drive gear of the shaft can intermesh with the driven gear of the driven rotor, wherein the at least one said driven rotor further comprises a pinion gear, and wherein at least a second driven rotor comprises a pinion gear adapted to intermesh with said pinion gear of said at least one driven rotor for driving said second driven rotor.

22. The glossal angle device of claim 21, wherein the axis of at least one driven rotor of the glossal angle is angled at 90 degrees relative to the axis of the driving shaft of the glossal angle.

23. The glossal angle device of claim 21, wherein the second face is characterized as generally arcuate.
